(19) United States
(12) Patent Application Publication
(10) Pub. No.: US 2012/0003441 A1
(43) Pub. Date: Jan. 5, 2012

(54) DECORATION FILM, DECORATION DEVICE, AND METHOD FOR MANUFACTURING DECORATION DEVICE

(75) Inventor: Chia-Fu Chen, Taoyuan County (TW)

(73) Assignee: SIPIX CHEMICAL INC., Taoyuan County (TW)

(21) Appl. No.: 12/829,353

(22) Filed: Jul. 1, 2010

(51) Int. Cl. B32B 5/16; B32B 38/14; B32B 3/10

(52) U.S. Cl. 428/206; 428/195.1; 156/277

(57) ABSTRACT

A decoration film, a decoration device and a method for manufacturing a decoration device are provided. The decoration film includes a substrate, a transparent material layer, a pattern layer, a plurality of aroma units and an adhesion layer. The transparent material layer is disposed on the substrate. The pattern layer is disposed on the transparent material layer at a side far from the substrate. The adhesion layer is exposed and disposed on the pattern layer. The aroma units are scattered in the transparent material layer, the pattern layer or the adhesion layer.

### BACKGROUND OF THE INVENTION

1. Field of the Invention

The present invention generally relates to a decoration film, a decoration device and a method for manufacturing a decoration device, in particular, to a decoration film having a plurality of aroma units, a decoration device and a method for manufacturing a decoration device.

2. Description of Related Art

Conventionally, the illustrations or decorations formed on the surface of the plastic housing are mainly fabricated by spraying process or printing process to present certain visual effect. Nevertheless, the spraying process is unfavorable in mass production for the disadvantages of time consumption and process complexity. In addition, the conventional spraying process may cause the splashing of sprays containing lead or other heavy metals so that the spraying material is wasted and the problem of pollution is caused. Furthermore, during the spraying process, the mass of the coating material is not easily controlled so that the thickness is usually uneven. Particularly, when the spraying process is performed on the curve portion of the housing, the improper accumulation of the coating material is worse.

To solve the abovementioned problem, specific decoration processes using a decoration film which has predetermined decoration layers formed on a substrate are provided. The decoration processes include an in-mold decoration (IMD) technique, a heat transfer printing process, a sublimation heat transfer process, a hot stamping process, an ink-jet printing process, a water transfer printing process, and the like. The process of the IMD technique includes placing the decoration film into a mold of the injection machine, injecting a melted resin at a side of the decoration film in the mold so that the melted resin and the decoration layers of the decoration film are combined to form a decoration device, and thereafter ejecting the decoration device from the mold. Accordingly, the in-mold decoration process is completed.

Decorating products not only give the products unique and stylish appearances, but also achieve other functions, anti-pirating among them. In order to relax both the body and mind of consumers, manufacturers devote themselves to developing application decorating film providing recreation effect, so as to reduce the working pressure of consumers and increase the fun of using decorating products.

### SUMMARY OF THE INVENTION

The invention directs to a decoration film having a plurality of aroma units.

The invention directed to a decoration device which can spread the special flavor to enhance the recreation effect.

The invention directed to a method for manufacturing a decoration device, so as to fabricate a decoration device aforementioned.

The invention provides a decoration film including a substrate, a transparent material layer, a pattern layer, a plurality of aroma units and an adhesion layer. The transparent material layer is disposed on the substrate. The pattern layer is disposed on the transparent material layer at a side far from the substrate. The adhesion layer is exposed and disposed on the pattern layer. The aroma units are scattered in the transparent material layer, the pattern layer or the adhesion layer.

In an embodiment of the invention, the transparent material layer is a releasing layer or a durable layer.

In an embodiment of the invention, the aroma units include a plurality of aroma capsules or a plurality of aroma particles.

In an embodiment of the invention, the aroma capsules or the aroma particles include a plurality of aromatic compounds.

In an embodiment of the invention, an average particle diameter of the aroma particles is between 100 nm and 5 μm.

In an embodiment of the invention, the adhesion layer covers the pattern layer and a portion of the transparent material layer.

The invention also provides a decoration device including a body and a decoration film. The body has an outer surface. The decoration film is disposed on the outer surface of the body, wherein the decoration film includes a transparent material layer, a pattern layer, a plurality of first aroma units and an adhesion layer. The transparent material layer is disposed above the outer surface of the body. The pattern layer is disposed on the transparent material layer. The adhesion layer is disposed on the pattern layer and located between the outer surface of the body and the transparent material layer, wherein the adhesion layer is closely attached to the outer surface of the body. The first aroma units are scattered in the transparent material layer, the pattern layer or the adhesion layer.

In an embodiment of the invention, the transparent material layer is a releasing layer or a durable layer.

In an embodiment of the invention, the first aroma units include a plurality of aroma capsules or a plurality of aroma particles.

In an embodiment of the invention, the aroma capsules or the aroma particles include a plurality of aromatic compounds.

In an embodiment of the invention, an average particle diameter of the aroma particles is between 100 nm and 5 μm.

In an embodiment of the invention, the body has a plurality of second aroma units, and the second aroma units scattered in the body.

The invention further provides a method for manufacturing a decoration device, and the method includes following steps. A substrate having a transparent material layer formed thereon is provided. A pattern layer is formed on the transparent material layer at a side far from the substrate. An adhesion layer is formed on the pattern layer, wherein the adhesion layer covers the pattern layer and a portion of the transparent material layer. A plurality of first aroma units adds to the transparent material layer, the pattern layer or the adhesion layer, wherein the first aroma units are scattered in the transparent material layer, the pattern layer or the adhesion layer. A body is formed on the adhesion layer so as to closely attach the body to the adhesion layer.

In an embodiment of the invention, a method of forming the body includes following steps. A plastic material with a plurality of second aroma units is disposed on the adhesion layer at a side far from the pattern layer. The plastic material with the second aroma units is cured to form the body, so that the decoration film is closely attached to the body by the adhesion layer.

In an embodiment of the invention, the plastic material with the second aroma units is selected from the group consisting of polycarbonate, polypropylene, polyacrylate, styrene-methyl methacrylate copolymer, acrylonitrile butadiene styrene, polystyrene, polyethylene terephthalate, polyoxymethylene and combinations thereof.

In an embodiment of the invention, a method for attaching the body to the adhesion layer closely includes following steps. The decoration film is disposed on the body. A heat transfer printing process is performed to the decoration film. The decoration film and the body are disposed in a chamber. Air is extracted from the chamber, so that the decoration film is closely attached to the body by the adhesion layer.

In an embodiment of the invention, the heat transfer printing process comprises a heating process and a pressing process.

In an embodiment of the invention, after the body is formed, the method further includes removing a substrate from the body by applying a release force.

In an embodiment of the invention, the transparent material layer is a releasing layer or a durable layer.

In an embodiment of the invention, the first aroma units include a plurality of aroma capsules or a plurality of aroma particles.

In an embodiment of the invention, the aroma capsules or the aroma particles include a plurality of aromatic compounds.

In an embodiment of the invention, an average particle diameter of the aroma particles is between 100 nm and 5 μm.

In view of the above, the decoration film of the present invention has the aroma units which are scattered in the transparent material layer, the pattern layer or the adhesion layer. After the transfer, the decoration film with the aroma units is thus formed on the outer surface of the body. Therefore, the special flavor (e.g. fragrance) are generated owing to the friction between the user and the outer surface of the body when a user pressing the decoration device by the fingers or other manners. Accordingly, the function of the decoration device is increased.

In order to make the aforementioned and other features and advantages of the invention more comprehensible, embodiments accompanying figures are described in detail below.

Herein, the same or similar reference numbers used in the drawings and the descriptions are referred as the same or similar elements. For clearly describing the concept of the invention, the shapes and the thickness of the elements in the embodiments accompanying with the drawings may not definitely comply with the real circumstance. In addition, the following descriptions are directed to the elements or the combinations thereof, but the elements are not particularly restricted in the contents or the descriptions. Any form or shape known by one skilled in the art is applicable in the invention. Moreover, the description that a material layer disposed on a substrate or disposed on another material layer means that the material layer is directly located on the substrate or another material layer, and may also mean that some interlayer is interrupted between the material layer and the substrate or between the material layer and another material layer.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic cross-sectional view of a decoration film according to one embodiment of the present invention.

FIG. 1B is a schematic cross-sectional view of a decoration film according to another embodiment of the present invention.

FIG. 2A is a schematic cross-sectional view of a decoration device according to one embodiment of the present invention.

FIG. 2B is a schematic cross-sectional view of a decoration device according to another embodiment of the present invention.

FIG. 3 is a flow chart of a method for manufacturing a decoration device according to one embodiment of the present invention.

### DESCRIPTION OF THE EMBODIMENTS

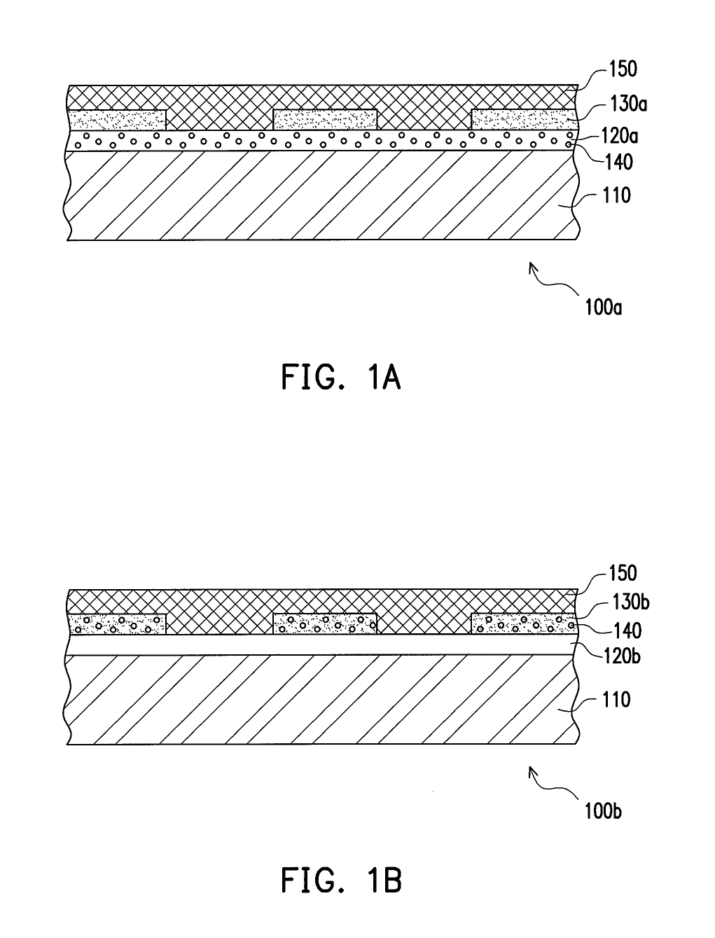

FIG. 1A is a schematic cross-sectional view of a decoration film according to one embodiment of the present invention. Referring to FIG. 1A, a decoration film 100a including a substrate 110, a transparent material layer 120a, a pattern layer 130a, a plurality of aroma units 140 and an adhesion layer 150 is provided. In more detail, the transparent material layer 120a is disposed on the substrate 110. The pattern layer 130a is disposed on the transparent material layer 120a at a side far from the substrate 110 and exposes a portion of the transparent material layer 120a. The aroma units 140 are scattered in the transparent material layer 120a. The adhesion layer 150 is exposed and disposed on the pattern layer 130a. Herein, the adhesion layer 150 covers the pattern layer 130a and a portion of the transparent material layer 120a.

In addition, a material of the substrate 110 can be polyethylene terephthalate (PET), polyethylene naphthalate (PEN), polyethylene glycol-co-cyclohexane-1,4 dimethanol terephthalate (PETG), thermalplastic polyurethane (TPU), polyurethane (PU), polypropylene (PP), polycarbonate (PC), amorphous polyethylene terephthalate (A-PET), polyvinyl chloride (PVC), Polystyrene (PS), triacetyl cellulose (TAC), polymethylmethacrylate (PMMA), methylmethacrylate-styrene (MMA-st, MS) copolymer, cyclo olefin copolymer (COC) and a combination thereof, but the invention is not restricted herein. It is noted that the substrate 110 is flexible for facilitating the subsequent process.

The transparent material layer 120a of the present embodiment is a durable layer. Herein, this durable layer can be regarded as a protective layer to the pattern layer 130a. Suitable raw materials for the durable layer may include, but are not limited to, radiation curable multifunctional acrylates including epoxy acrylates, polyurethane acrylates, polyester acrylates, silicone acrylates, glycidyl acrylates, epoxides, vinyl esters, diallyl phthalate, vinyl ethers and blends thereof. The durable layer may comprise a condensation polymer or copolymer, such as epoxy, polyurethane, polyamide, polyimide, melamine formaldehyde, urea formaldehyde or phenol formaldehyde. The durable layer may comprise a sol-gel silicate or titanium ester.

The durable layer may be partially or fully cured. If partially cured, a post curing step will be employed after the molding and/or transferring step to enhance the durability, particularly hardness, scratch and oil resistance. In addition, to improve the release properties, the raw material, particularly the low molecular weight components of the durable layer is preferably not permeable into the other layer. After the durable layer is coated and cured or partially cured, it should be marginally compatible or incompatible with the other layer. Binders and additives such as thickeners, surfactants, dispersants, UV stabilizers or antioxidants may be used to control the rheology, wettability, coating properties, weatherability and aging properties. Fillers such as silica, Al.sub.2O.sub.3, TiO.sub.2, CaCO.sub.3, microcrystalline wax or polyethylene, Teflon or other lubricating particles may also be added to improve, for example, scratch resistance and hardness of the durable layer. The durable layer is usually about 2 to about 20 microns, preferably about 3 to about 12 microns in thickness. The durable layer, if present, is preferably transparent in a window area.

In addition to the materials described above, other suitable compositions for the optional durable layer are disclosed in US 2005-0181204, US 2005-0171292, and US 2006-0093813, the contents of all of which are incorporated herein by reference in their entirely. For example, US 2005-0181204 discloses a durable layer composition which comprises a thermally crosslinkable and photochemically or radically graftable polymer, a thermal crosslinker and a radiation curable multifunctional monomer or oligomer; US 2005-0171292 discloses a durable layer composition which comprises a polymer or copolymer having at least one carboxylic acid or acid anhydride functionality for thermal crosslinking and at least one UV crosslinkable functionality; and US 2006-0093813 discloses a durable layer composition which comprises an amino crosslinker, a UV curable monomer or oligomer having at least one functional group reactive with the amino crosslinker, an acid catalyst; and a photoinitiator.

The pattern layer 130a can be made of any ink or printable material by the printing. Specifically, the aroma units 140 of the present embodiment include a plurality of aroma capsules or a plurality of aroma particles. Herein, the aroma capsules or the aroma particles are scattered in the transparent material layer 120a. The aroma capsules or the aroma particles are a plurality of aromatic compounds, for example. An average particle diameter of the aroma particles is between 100 nm and 5 μm, for example.

The adhesion layer 150 can be made of polyacrylate, polymethacrylate, polystyrene, polycarbonate, polyurethane, polyester, polyamide, epoxy resin, ethylene vinyl acetate (EVA), thermoplastic elastomer, the like, a copolymer thereof, a blend thereof, or a mixture thereof.

In the decoration film 100a of the present embodiment, the aroma units 140 are scattered in the transparent material layer 120a. Therefore, compared with the prior art, the decoration film 100a of the present embodiment can spread a special flavor, such as fragrance, so that the function of the decoration film 100a can be increased.

FIG. 1B is a schematic cross-sectional view of a decoration film according to another embodiment of the present invention. Referring to FIGS. 1A and 1B, the decoration film 100b in FIG. 1B is similar to the decoration film 100a in FIG. 1A except that the aroma units 140 of the decoration film 100b in FIG. 1B has a different disposing position. In more details, the transparent material layer 120b of the present embodiment is a releasing layer, and the aroma units 140 are scattered in the pattern layer 130b. Herein, the releasing layer (transparent material layer 120b) is configured for temporally adhering the substrate 110 and the pattern layer 130b in order to facilitate lifting off the substrate 110 after the transfer process. Accordingly, this releasing layer is usually a thin film with low surface tension which can be made of a wax, a paraffin, or silicone, or an impermeable thin film with high smoothness which can be made of an irradiation curable multi-functional acrylic, silicone acrylate, epoxy, vinyl, allyl vinyl compound, unsaturated polyester or a mixture thereof. A material of the releasing layer can be selected from a polycondensate, a copolymer, a blend, or a mixture consisting of epoxy, polyurethane, polyimide, polyamide, hexa methoxymethyl melamine-formaldehyde, urea-formaldehyde, phenol-formaldehyde, and a combination thereof.

Certainly, in other embodiments, the aroma units 140 can also be scattered in the adhesion layer 150, which the present invention is not limited to. In brief, the aroma units 140 of the present embodiment can be scattered in the transparent material layer 120a, the pattern layer 130b or the adhesion layer 150.

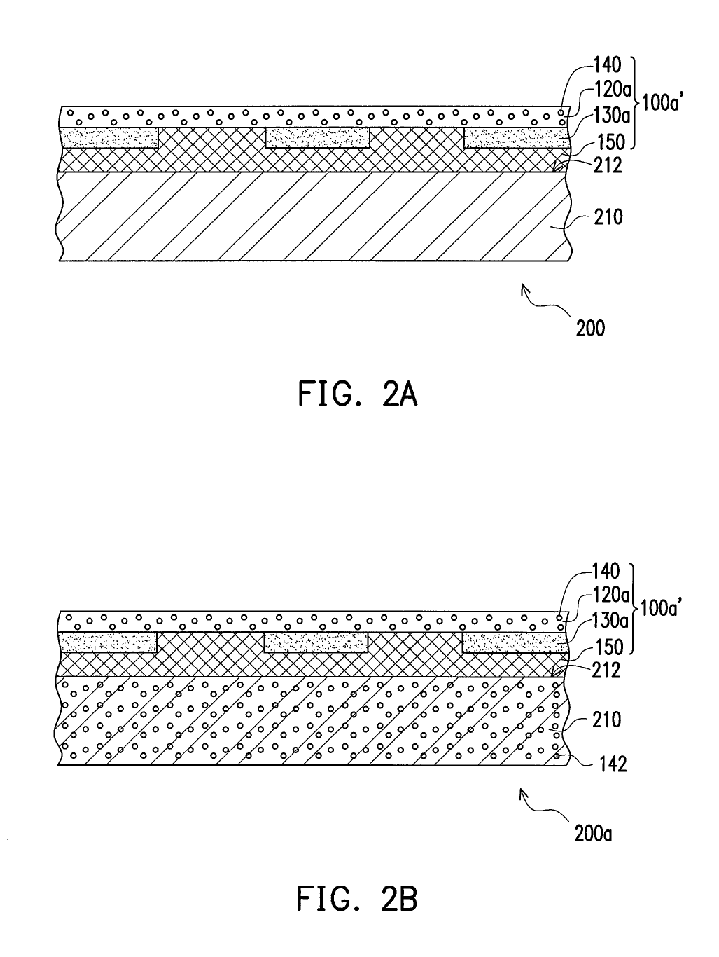

FIG. 2A is a schematic cross-sectional view of a decoration device according to one embodiment of the present invention. Referring to FIG. 2A, a decoration device 200 including a body 210 and a decoration film 100a′ is provided. Herein, the decoration film 100a′ of the present embodiment can be transferred onto the body 210 by a transfer process to form the decoration device 200. The transfer process includes an in-mold labelling (IML), an in-mold film (IMF), an in-mold roller (IMR), a heat transfer printing, a sublimation heat transfer, a hot stamping, an ink-jet printing and water transfer printing.

In more detail, the body 210 has an outer surface 212. A material of the body 210 can be polycarbonate (PC), acrylonitrile butadiene styrene (ABS), polymethylmethacrylate (PMMA), polyoxymethylene (POM), polybutylene terephthalate (PBT), polypropylene (PP), polymethylmethacrylate (PMMA), MMA-St (MS), acrylonitrile butadiene styrene (ABS), polystyrene (PS), polyethylene terephthalate (PET), polyoxymethylene (POM) and a combination thereof, but the invention is not restricted herein.

The decoration film 100a′ is disposed on a portion of the outer surface 212 of the body 210, and the decoration film 100a′ of the present embodiment includes a transparent material layer 120a, a pattern layer 130a, a plurality of aroma units 140 and an adhesion layer 150. The transparent material layer 120a is disposed above the outer surface 212 of the body 210. The pattern layer 130a is disposed on the transparent material layer 120a and exposes a portion of the transparent material layer 120a. The aroma units 140 are scattered in the transparent material layer 120a. The adhesion layer 150 is disposed on the pattern layer 130a and located between the outer surface 212 of the body 210 and the transparent material layer 120a, wherein the adhesion layer 150 is closely attached to the outer surface 212 of the body 210.

The materials and the formulation information of the transparent material layer 120a, the pattern layer 130a, the aroma units 140 and the adhesion layer 150 have been described above therefore will not be described herein. Thus, a relevant illustration can be referred to the foregoing embodiments. In should be noted that, in the present embodiment, the transparent material layer 120a is configured for protecting the pattern layer 130a, namely, the transparent material layer 120a can be regarded as a durable layer. The disposition of the transparent material layer 120a in other embodiments may be omitted, namely, the transparent material layer 120b can be regarded as a releasing layer, as shown in FIG. 1B, after the transfer process, the transparent material layer 120b is removed from the body 210.

It should be noted that although the above-mentioned aroma units 140 is exemplarily disposed in the transparent material layer 120a, but in other unshown embodiments, the aroma units 140 can be disposed in the pattern layer 130b (as shown is FIG. 1B) or disposed in the pattern layer 130a and the transparent material layer 120a, which the present invention is not limited to.

In the present embodiment, the decoration device 200 has the decoration film 100a′ with the aroma units 140 scattered in the transparent material layer 120a. Therefore, the special flavor (e.g. fragrance) are generated owing to the friction between the user and the outer surface 212 of the body 210 when a user pressing the decoration device 200 by the fingers or other manners. Accordingly, the function of the decoration device 200 is increased.

FIG. 2B is a schematic cross-sectional view of a decoration device according to another embodiment of the present invention. Referring to FIGS. 2A and 2B, a decoration device 200a in FIG. 2B is similar to the decoration device 200 in FIG. 2A except that a plurality of aroma units 142 are scattered in the body 210. In the present embodiment, the aroma units 142 are substantially the same as the aroma units 140, namely, the aroma units 142 also include a plurality of aroma capsules or a plurality of aroma particles, and the aroma capsules or the aroma particles are a plurality of aromatic compounds, for example. In addition, an average particle diameter of the aroma particles is between 100 nm and 5 μm, for example.

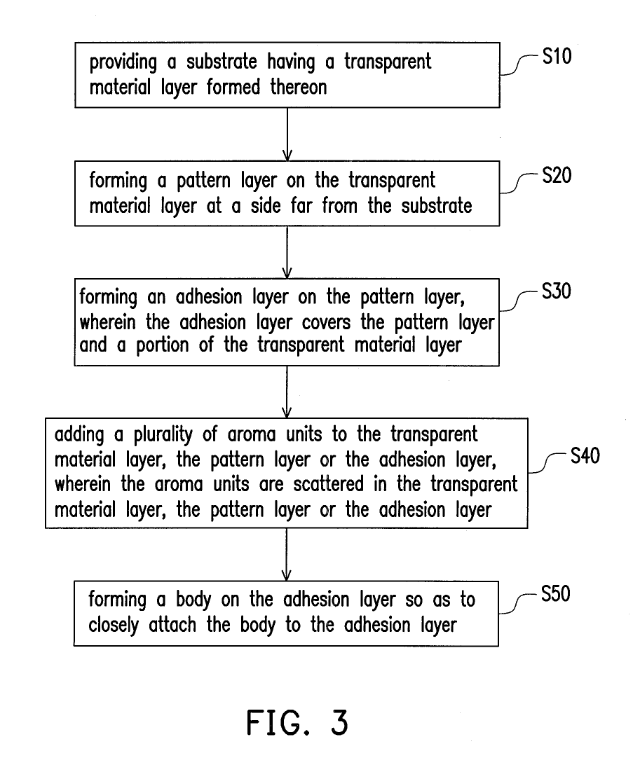

In the aforementioned descriptions, only the decoration film 100a, 100b and the decoration device 200, 200a are introduced, and a manufacturing method thereof is not mentioned. Therefore, one embodiments is provide below for describing the manufacturing method of the decoration device 200 (or 200a) is described in detail with reference of FIG. 3.

FIG. 3 is a flow chart of a method for manufacturing a decoration device according to one embodiment of the present invention. Referring to FIGS. 1A (or 1B) and 3, according to the manufacturing method of the decoration device 200 (or 200a) of the present embodiment, first, the substrate 110 having the transparent material layer 120a formed thereon is provided, step S10. The transparent material layer 120a may be a releasing layer or a durable layer. In the present embodiment, the transparent material layer 120a is a durable layer, for example. The materials of the substrate 110 and the transparent material layer 120a have been described above therefore will not be described herein.

Next, referring to FIGS. 1A and 3, the pattern layer 130a is formed on a portion of the transparent material layer 120a at a side far from the substrate 110, step 20. Herein, a method of forming the pattern layer 130a may be carried out by any printing techniques, such as flexographic, driographic, electro photographic or lithographic printing. Other printing techniques, such as stamping, screen printing, gravure printing, ink jet printing or thermal printing may also be suitable.

Next, referring to FIGS. 1A and 3, a plurality of aroma units 140 add to the transparent material layer 120a, wherein the aroma units 140 are scattered in the transparent material layer 120a, step 40. In more detail, the aroma units 140 include a plurality of aroma capsules or a plurality of aroma particles, and the aroma capsules or the aroma particles are a plurality of aromatic compounds, for example. In addition, an average particle diameter of the aroma particles is between 100 nm and 5 μm, for example. It should be noted that the aroma units 140 in other embodiment can be add to the pattern layer 130a, as shown in FIG. 1B, which the present invention is not limited to.

Next, referring to FIGS. 1A and 3, the adhesion layer 150 is formed on the pattern layer 130, wherein the adhesion layer 150 covers the pattern layer 130 and a portion of the transparent material layer 120a, step 30. Now, manufacturing of the decoration film 100a (or 100b) with the aroma units 140 is completed. It should be noted that in other embodiment, the aroma units 140 can be added to the adhesion layer 150, step 30, after forming the adhesion layer 150, step 40, which the present invention is not limited to.

Finally, referring to FIGS. 2A and 3, the body 210 is formed on the adhesion layer 150 so as to closely attach the body 210 to the adhesion layer 150, step S50. In more detail, in the present embodiment, the decoration film 100a (or 100b) adheres to the outer surface 212 of the body 210 through the adhesion layer 150. A method of forming the body 210 includes following steps. First, a plastic material is disposed on the adhesion layer 150 at a side far from the pattern layer 130a (or 130b), and then, the plastic material is cured to form the body 210, so that the decoration film 100a (or 100b) is closely attached to the body 210 by the adhesion layer 150. Herein, the plastic material is selected from the group consisting of polycarbonate, polypropylene, polyacrylate, styrene-methyl methacrylate copolymer, acrylonitrile butadiene styrene, polystyrene, polyethylene terephthalate, polyoxymethylene and combinations thereof, but are not limited to. After the body 210 is formed, the substrate 110 can be released from the body 210 by applying a release force to expose the transparent material layer 120a (or the pattern layer 130a). Now, manufacturing of the decoration device 200 with the aroma units 140 which can spread a special flavor, such as fragrance is completed.

Certainly, in other embodiment, referring to FIGS. 2B and 3, the body 210 with the aroma units 142 is formed on the adhesion layer 150 so as to closely attach the body 210 to the adhesion layer 150, step S50. In more detail, a method of forming the body 210 with the aroma units 142 includes following steps. First, a plastic material with a plurality of aroma units 142 is disposed on the adhesion layer 150 at a side far from the pattern layer 130a (or 130b), and then, the plastic material with the aroma units 142 is cured to form the body 210, so that the decoration film 100a (or 100b) is closely attached to the body 210 by the adhesion layer 150. Herein, the plastic material with the aroma units 142 is selected from the group consisting of polycarbonate, polypropylene, polyacrylate, styrene-methyl methacrylate copolymer, acrylonitrile butadiene styrene, polystyrene, polyethylene terephthalate, polyoxymethylene and combinations thereof, but are not limited to. Therefore, manufacturing of the decoration device 200a with the aroma units 140,142 which are scattered in the transparent material layer 120a and the body 210 and can spread a special flavor, such as fragrance is completed.

In other embodiments, a method for attaching the body 210 (or the body 210 with the aroma units 142) to the adhesion layer 150 closely may be used the following steps. First, the decoration film 100a (or 100b) is disposed on the body 210 (or the body 210 with the aroma units 142). Next, a heat transfer printing process is performed to the decoration film 100a (or 100b). Herein, the heat transfer printing process includes a heating process and a pressing process. The substrate 110 of the decoration film 100a (or 100b) is pressurized and heated, such that the adhesion layer 150 adheres on the body 210 (or the body 210 with the aroma units 142). Next, the decoration film 100a (100b) and the body 210 (or the body 210 with the aroma units 142) are disposed in a chamber. Then, air is extracted from the chamber, so that the decoration film 100a (or 100b) is closely attached to the body 210 (or the body 210 with the aroma units 142) by the adhesion layer 150. Finally, the substrate 110 can be released from the body 210 (or the body 210 with the aroma units 142) by applying a release force to expose the transparent material layer 120a (or the pattern layer 130a). Now, manufacturing of the decoration device 200 (or the decoration device 200a) with the aroma units 140 which can spread a special flavor, such as fragrance is completed.

In summary, the decoration film of the present invention has the aroma units which are scattered in the transparent material layer, the pattern layer or the adhesion layer. After the transfer process, the decoration film with the aroma units is thus formed on the outer surface of the body. Therefore, the special flavor (e.g. fragrance) are generated owing to the friction between the user and the outer surface of the body when a user pressing the decoration device by the fingers or other manners. Accordingly, the function (such as recreation effect) of the decoration device is increased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A decoration film, comprising:
a substrate;
a transparent material layer disposed on the substrate;
a pattern layer disposed on the transparent material layer at a side far from the substrate;
an adhesion layer disposed on the pattern layer and being exposed; and
a plurality of aroma units scattered in the transparent material layer, the pattern layer or the adhesion layer.

2. The decoration film as claimed in claim 1, wherein the transparent material layer is a releasing layer or a durable layer.

3. The decoration film as claimed in claim 1, wherein the aroma units include a plurality of aroma capsules or a plurality of aroma particles.

4. The decoration film as claimed in claim 3, wherein the aroma capsules or the aroma particles include a plurality of aromatic compounds.

5. The decoration film as claimed in claim 3, wherein an average particle diameter of the aroma particles is between 100 nm and 5 μm.

6. The decoration film as claimed in claim 1, wherein the adhesion layer covers the pattern layer and a portion of the transparent material layer.

7. A decoration device, comprising:
a body having an outer surface; and
a decoration film disposed on the outer surface of the body, wherein the decoration film comprises:
a transparent material layer disposed above the outer surface;
a pattern layer disposed on the transparent material layer;
an adhesion layer disposed on the pattern layer and located between the outer surface of the body and the transparent material layer, wherein the adhesion layer is closely attached to the outer surface of the body; and
a plurality of first aroma units scattered in the transparent material layer, the pattern layer or the adhesion layer.

8. The decoration device as claimed in claim 7, wherein the transparent material layer is a releasing layer or a durable layer.

9. The decoration device as claimed in claim 7, wherein the first aroma units include a plurality of aroma capsules or a plurality of aroma particles.

10. The decoration device as claimed in claim 9, wherein the aroma capsules or the aroma particles include aromatic compounds.

11. The decoration device as claimed in claim 9, wherein an average particle diameter of the aroma particles is between 100 nm and 5 μm.

12. The decoration device as claimed in claim 9, wherein the body has a plurality of second aroma units, and the second aroma units scattered in the body.

13. A method for manufacturing a decoration device, comprising:
providing a substrate having a transparent material layer formed thereon;
forming a pattern layer on the transparent material layer at a side far from the substrate;
forming an adhesion layer on the pattern layer, wherein the adhesion layer covers the pattern layer and a portion of the transparent material layer;
adding a plurality of first aroma units to the transparent material layer, the pattern layer or the adhesion layer, wherein the first aroma units are scattered in the transparent material layer, the pattern layer or the adhesion layer; and
forming a body on the adhesion layer so as to closely attach the body to the adhesion layer.

14. The method for manufacturing the decoration device as claimed in claim 13, wherein a method of forming the body comprises:
disposing a plastic material with a plurality of second aroma units on the adhesion layer at a side far from the pattern layer; and
curing the plastic material with the second aroma units to form the body, so that the decoration film is closely attached to the body by the adhesion layer.

15. The method for manufacturing the decoration device as claimed in claim 14, wherein the plastic material with the second aroma units is selected from the group consisting of polycarbonate, polypropylene, polyacrylate, styrene-methyl methacrylate copolymer, acrylonitrile butadiene styrene, polystyrene, polyethylene terephthalate, polyoxymethylene and combinations thereof.

16. The method for manufacturing the decoration device as claimed in claim 13, wherein a method for attaching the body to the adhesion layer closely comprises:
disposing the decoration film on the body;
performing a heat transfer printing process to the decoration film;
disposing the decoration film and the body in a chamber; and
extracting air from the chamber, so that the decoration film is closely attached to the body by the adhesion layer.

17. The method for manufacturing the decoration device as claimed in claim 16, wherein the heat transfer printing process comprises a heating process and a pressing process.

18. The method for manufacturing the decoration device as claimed in claim 13, wherein after the body is formed, the method further comprises:
removing a substrate from the body by applying a release force.

19. The method for manufacturing the decoration device as claimed in claim 13, wherein the transparent material layer is a releasing layer or a durable layer.

20. The method for manufacturing the decoration device as claimed in claim 13, wherein the first aroma units include a plurality of aroma capsules or a plurality of aroma particles.

21. The method for manufacturing the decoration device as claimed in claim 20, wherein the aroma capsules or the aroma particles include a plurality of aromatic compounds.

22. The method for manufacturing the decoration device as claimed in claim 20, wherein an average particle diameter of the aroma particles is between 100 nm and 5 μm.
